(19) United States
(12) Patent Application Publication
(10) Pub. No.: US 2026/0250541 A1
(43) Pub. Date: Aug. 27, 2026

(54) POLYMER COMPOUND

(71) Applicant: KYUSHU UNIVERSITY, NATIONAL UNIVERSITY CORPORATION, Fukuoka-shi, Fukuoka (JP)

(72) Inventors: Shingo KOBAYASHI, Fukuoka-shi (JP); Kento YOSHIDA, Fukuoka-shi (JP); Masaru TANAKA, Fukuoka-shi (JP)

(21) Appl. No.: 18/995,485

(22) PCT Filed: Jul. 14, 2023
(86) PCT No.: PCT/JP2023/025987

§ 371 Date: May 22, 2025

(30) Foreign Application Priority Data
Jul. 16, 2022 (JP) 2022-114418

(51) Int. Cl. C09D 143/04; C08F 8/02; C08F 130/08

(52) U.S. Cl. CPC C09D 143/04; C08F 8/02; C08F 130/08

(57) ABSTRACT

What is provided is a novel polymer compound which has a chain-like ether structure and exhibits biocompatibility. A polymer compound which has a polyolefin skeleton as a main chain and has a structure including a chain-like ether structure introduced into a side chain moiety thereof.

### TECHNICAL FIELD

The present invention relates to a novel polymer compound, a surface treatment composition containing the polymer compound, and the like. Priority is claimed on Japanese Patent Application No. 2022-114418, filed Jul. 16, 2022, the content of which is incorporated herein by reference.

### BACKGROUND ART

In general, it is known that in a case where a biological component such as blood comes into contact with a surface of various materials, the surface of the material is recognized as a foreign substance, and nonspecific adsorption, denaturation, multilayer adsorption, and the like of proteins in a biological tissue occur, and as a result, activation of a coagulation system, a complement system, a platelet system, and the like occurs. Therefore, on the surface of the medical device that is used in contact with a living body, it is desirable to impart biocompatibility to the surface of the device for preventing the device from being recognized as a foreign substance to prevent a foreign-substance reaction with the biological component.

As a means for imparting biocompatibility to the surface of various medical devices, attempts have been made in the related art to artificially synthesize a material having biocompatibility and use the material by applying the material to the surface of the medical device. As such a biocompatible material, a 2-methacryloyloxyethyl phosphorylcholine (MPC) polymer, polyethylene glycol (PEG), poly(2-methoxyethyl acrylate) (PMEA), and the like are typically known. By constituting a portion of a medical device surface or the like, which comes into contact with a biological component such as blood, with these biocompatible materials, the medical device surface is prevented from being recognized as a foreign substance, and as a result, biocompatibility such as suppression of activation of a coagulation system, a complement system, a platelet system, and the like is exhibited. Therefore, these biocompatible materials are put into practical use as a material constituting a portion of a medical device that comes into contact with blood or the like.

It has been revealed that the above-described polymer exhibiting biocompatibility generally exhibits predetermined hydrophilicity, and in a case where the polymer is hydrated by containing water, the polymer contains water molecules in a form referred to as “intermediate water” (freezing-bound water) in the hydrated structure. The intermediate water is characterized by the movement of latent heat associated with the regularization/irregularization of water molecules in a temperature range lower than the freezing point, and is understood as water molecules in a state of exhibiting intermediate characteristics with respect to antifreeze water that is strongly constrained on the surface of the substance and free water that is hardly constrained by the surface of the substance. It is considered that the polymer that generates intermediate water in the hydrated structure generates intermediate water at a ratio according to the structure thereof, and plays an important role in the exhibition of biocompatibility (for example, see Patent Document 1).

The reason why each of the polymers generates a hydrated structure containing intermediate water in a case of containing water is not always clear, but the presence of a structure common to polymers that generate a hydrated structure containing intermediate water has been clarified by the research in the related art.

The PEG is known to be a polymer having —(C₂H₄—O)—, which is a type of chain-like ether structure, as a repeating unit, to contain intermediate water when containing water, and to have extremely excellent biocompatibility. In addition, it is known that the PMEA has a structure in which a side chain having —(C₂H₄—O)—, which is a constitutional unit of the PEG, as a main structure is bonded to an acrylic skeleton, and has a biocompatibility by containing intermediate water when containing water. In addition, Patent Document 2 describes that a polymer exhibiting good biocompatibility can be configured by introducing a chain-like ether structure as a side chain to a (meth)acrylamide skeleton.

In addition, for example, Patent Document 1 describes that the amount of intermediate water that can be contained and the soluble solvent are changed by changing the number of carbon atoms constituting the chain-like ether structure included in the side chain moiety and changing the number of repetition, or the like of the chain-like ether structure. Furthermore, Patent Document 3 states that a polymer obtained by polymerizing a diene-based monomer into which a chain-like ether structure is introduced exhibits biocompatibility such as antithrombotic properties.

### CITATION LIST

### Patent Documents

Patent Document 1: Japanese Unexamined Patent Application, First Publication No. 2017-82174
Patent Document 2: Japanese Unexamined Patent Application, First Publication No. 2004-357826
Patent Document 3: Japanese Unexamined Patent Application, First Publication No. 2021-63159

### SUMMARY OF INVENTION

### Technical Problem

As described above, it has been clarified that a polymer compound capable of generating a hydrated structure containing intermediate water in a case of containing water in the polymer can be constituted by including a chain-like ether structure represented by the general formula of —(CₓH₂ₓ—O)— as a part of the polymer compound. On the other hand, in a polymer compound including a chain-like ether structure in a part thereof, the polymer compound exhibits different characteristics depending on the structure of a portion other than the chain-like ether structure. Therefore, it is expected to provide a polymer compound depending on the use application of the polymer compound, or the like.

An object of the present invention is to provide a novel polymer compound which has a chain-like ether structure and exhibits biocompatibility.

### Solution to Problem

The present invention provides the following means to solve the above-described problems.
(1) A polymer compound containing:
a repeating unit represented by Formula (1). Provided that in Formula (1), R₁ represents a hydrogen atom or a monovalent hydrocarbon group having 12 or less carbon atoms which may have an ether bond, R₂ represents a divalent saturated hydrocarbon group containing a linear or branched carbon chain having 1 to 6 carbon atoms, R₃ represents a monovalent hydrocarbon group having 6 or less carbon atoms which may have an ether bond, m represents a natural number of 1 or 2, and n represents the number of repetitions of the repeating unit.

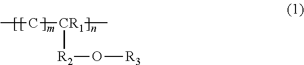

(2) The polymer compound in which R₂ is a divalent saturated hydrocarbon group selected from the group consisting of —CH₂—, —CH₂CH₂—, —CH(CH₃)—, —CH₂CH₂CH₂—, —CH(CH₃)CH₂—, —CH₂(CH₂)₂CH₂—, —CH(CH₃)CH₂CH₂—, —CH₂(CH)(CH₃)CH₂—, —CH(CH₃)CH(CH₃)—, —CH₂(CH₂)₃CH₂—, —CH(CH₃)(CH₂)₂CH₂—, —CH₂(CH₂)₂C(CH₃)₂—, and —CH₂(CH₂)₄CH₂—.
(3) The polymer compound in which R₃ is a monovalent hydrocarbon group selected from the group consisting of CH₃, —CH₂CH₃, —(CH₂)₂CH₃, —(CH₂)₃CH₃, —(CH₂)₄CH₃, and —(CH₂)₅CH₃.
(4) The polymer compound in which a proportion of a structure represented by Formula (1) to the number (n) of repeating units constituting the polymer compound is 51 mol % or more.
(5) A polymer composition containing the polymer compound according to any one of (1) to (4).
(6) A coating composition obtained by dissolving the polymer compound according to any one of (1) to (4) in a solvent.
(7) A medical device including a surface at least a part of which is coated with the polymer compound according to any one of (1) to (4).

### Advantageous Effects of Invention

According to the polymer compound according to the embodiment of the present invention, a polymer compound exhibiting good biocompatibility and having particularly excellent adhesiveness to a base material is provided, and the polymer compound can be suitably used for forming a surface of a member, which requires the exhibition of various biocompatibilities.

### BRIEF DESCRIPTION OF DRAWINGS

FIG. 1A ¹H NMR spectrum of 4-pentene-1-ol protected with a TBS group.

FIG. 2 A ¹H NMR spectrum of a 4-pentene-1-ol polymer protected with a TBS group.

FIG. 3 A ¹H NMR spectrum of a 4-pentene-1-ol polymer after deprotection.

FIG. 4 A ¹H NMR spectrum of a polymer after methylation.

FIG. 5 An infrared absorption spectrum of the polymer after methylation.

FIG. 6 A stereoscopic micrograph showing the appearance of a PP substrate coated with a polymer compound.

FIG. 7 A graph showing a contact angle by a liquid droplet method on a surface of each polymer compound.

FIG. 8 A graph showing a contact angle by a liquid droplet method and a contact angle by a captive bubble method on the surface of each polymer compound.

FIG. 9 A graph showing the frequency of platelet adhesion on the surface of each polymer compound.

### DESCRIPTION OF EMBODIMENTS

It is considered that at the interface between the hydrophobic polymer and the water phase, a substantial interaction does not occur between the polymer molecules constituting the polymer and the water molecules, and a clear interface is maintained between the polymer and the water phase. On the other hand, it is known that in a case where a polymer exhibiting hydrophilicity is equilibrated with a water phase, a complex interface structure (hydrated structure) is formed by a hydration reaction or the like between a polymer molecule constituting the polymer and a water molecule, and it is considered that various polymers are classified into hydrophobicity or hydrophilicity depending on the presence or absence of an interaction with the water phase (water molecule).

It is known that water molecules that are generally strongly restrained by polymer molecules and cannot cause phenomena such as solidification and melting, which are inherent to water molecules, in a case where a temperature history such as heating or cooling is added, are present within a hydrated structure formed on the surface of the hydrophilic polymer that is in equilibrium with the water phase, and water molecules in such a state are generally referred to as “antifreeze water”. In addition, it is known that water molecules in a state referred to as “free water” that is weakly restrained by cohesive force or the like with the water molecules constituting the unfrozen water and that causes solidification, melting, or the like in the same manner as a single-phase water phase are present in the outer shell of the antifreeze water.

On the other hand, it has been confirmed that, for example, water molecules exhibiting behavior different from that of antifreeze water or free water are present in the hydrated structure in which the polymer described in Patent Documents 1 to 3, or the like is hydrated with the water phase. That is, in a case where a temperature change is made in a range of about −100° C. to 0° C. in a state where the polymer described in Patent Documents 1 to 3, or the like is hydrated, it is considered that the movement of latent heat considered to be caused by the phase transition of the water molecules between the regular state and the irregular state is observed, and the water molecules that generate the latent heat are water molecules in a state different from antifreeze water that does not cause the phase transition such as solidification, melting, or the like, or free water that causes solidification, melting, or the like in the same manner as a single-phase water phase. Therefore, the water molecules in a state where the phase transition occurs in the temperature range below the freezing point are defined as “intermediate water” and distinguished from antifreeze water and free water. Then, it has been observed that the interaction between the polymer and a biological substance such as a protein or a cell change depending on the content of the intermediate water, and the biocompatibility is exhibited (see Patent Documents 1 to 3, and the like).

That is, it is presumed that the exhibition of the biocompatibility exhibited by various polymers is caused by the affinity generated between the polymer and the water molecule. Then, in a case where the polymer having particularly high hydrophilicity, such as PEG, is brought into contact with the water phase, biocompatibility is exhibited, and the characteristics of the water-soluble polymer that is dissolved in water are exhibited. It is presumed that this is a result of the fact that the binding between the polymer molecules is difficult to maintain as a result of the binding of water molecules to the periphery of the molecular chain of the polymer at a high density.

It is known that with respect to the PEG, the polymer such as PMEA, which has a structure of —(C₂H₄—O)—, which is a constitutional unit constituting the PEG, in a side chain moiety with respect to a polymer main chain, causes hydration with a predetermined amount of water molecules while exhibiting water-insolubility. This is a result of the fact that since hydration with water molecules mainly occurs in the side chain moiety and the degree of hydration in the skeleton moiety of the polymer is low, the bond between the polymer molecules is maintained, it is considered to be indicate that the chain-like ether structure such as —(C₂H₄—O)— is combined with other polymer structures, thereby a polymer compound that exhibits biocompatibility and has various properties can be constituted.

It is noted that in the specification of the present application, among polymers that cause hydration between water molecules, a polymer that does not exhibit water solubility may be referred to as a hydrating polymer. In addition, in the specification of the present application, the terms “polymer” and “polymeride” are used interchangeably to refer to a compound (molecule) having a structure constituted by repeating monomer units. In addition, in the polymer (polymeride), the repeating unit constituting the polymer may be referred to as a monomer unit. In addition, the term “macromolecule” is used to indicate a giant molecule in which a large number of atoms are covalently bonded, such as a protein or a nucleic acid, in addition to a polymer.

In addition, the term “chain-like ether structure” is used to mean a structure in which one or a plurality of unit structures in which one end of an alkylene group is replaced with an ether bond (—O—) are linked.

As a result of various studies on various polymers having a chain-like ether structure in a side chain moiety, the present inventors have found that a hydrophilic polymer having an amorphous structure is generated by using a polyolefin skeleton as a main chain and introducing a structure including a chain-like ether structure into a side chain moiety thereof, and a polymer compound exhibiting biocompatibility and high adhesiveness in a case of being applied to various base materials, or the like can be constituted, thereby completing the present invention.

A coating film obtained by applying a polymer compound, in which a structure including a chain-like ether structure is introduced as a side chain to a polyolefin skeleton according to the embodiment of the present invention, into various base materials made of a resin exhibits water-insolubility, and is particularly preferably used for imparting biocompatibility to the surface of a medical device or the like since the film hardly undergoes a change in form such as non-uniformity of a film thickness even in a case of being brought into contact with a water phase for a long time.

In a case where the above-described PMEA, which is constituted by introducing a structure including a chain-like ether structure as a side chain to an acrylic skeleton, is used and the PMEA is immersed in a water phase for a long time in a state of being applied to a base material made of a resin such as PET, a tendency of causing so-called dewetting is observed in which, on the surface of the base material made of a resin, the film thickness of the coating film constituted by the PMEA is non-uniform and a spotted pattern including minute hill-like protrusions is generated.

With respect to the PMEA or the like, the coating film formed on a surface of various base materials by the polymer compound according to the embodiment of the present invention exhibits high adhesiveness to various base materials, can stably maintain the form even in a case of being in contact with a water phase for a long time, and can be particularly preferably used for imparting biocompatibility to the surface of a medical device such as an artificial heart and lung that is desired to be continuously used for a long time.

As described above, the reason why the adhesiveness to the base material made of a resin is improved by setting the main chain structure of the polymer compound to the polyolefin skeleton, and particularly, the dewetting is unlikely to occur even in a case of being immersed in the water phase for a long time is considered as follows.

That is, as described above, it is considered that the acrylic skeleton, which is the main chain moiety of PMEA or the like, is less likely to be hydrated with water molecules, and as a result, the cohesive force between the main chain moieties adjacent to each other is maintained, and thus the entire compound exhibits water-insolubility. However, in a case where the polymer is immersed in a water phase for a long time or the like, since the acrylic skeleton moiety is also hydrated to some extent, the cohesive force generated in the main chain moiety is reduced, thereby the fluidity is generated. In particular, it is presumed that this is a result of the fact that the PMEA flows in a direction in which the interaction with the base material made of a resin is reduced due to the interface free energy between the PMEA and a different type of the base material made of a resin.

On the other hand, it is presumed that since the polyolefin constituting the main chain of the polymer compound according to the embodiment of the present invention is constituted by a simple bond between carbons and does not contain a polar functional group that is likely to cause hydration, the hydration in the main chain moiety is less likely to occur even in a case of being immersed in the water phase for a long time, compared to the acrylic skeleton or the like, and the adhesion strength at the interface with the base material made of a resin and the form of the coating film are less likely to change.

By utilizing the fact that the coat film containing the polymer compound according to the embodiment of the present invention can maintain the adhesion strength to various base materials made of resins even in a case where the coat film is brought into contact with a water phase for a long time, or the like, particularly, in use applications in which various forces are applied to the coat film by being brought into contact with the flow of blood, or the like in the artificial heart and lung, and the coat film is likely to be peeled off from the surface of the base material, the coat film can exhibit the biocompatibility for a long period of time.

In addition, in the polymer compound according to the embodiment of the present invention, it has been found that the time required for the polymer to be hydrated to form a stable hydrated structure and the water content in a case where the polymer compound is brought into content with water are changed depending on the introduction density in a case of introducing a side chain moiety including a chain-like ether structure to the polyolefin skeleton. That is, it has been found that, by introducing one side chain for every two carbon atoms constituting the main chain or one side chain for every three carbon atoms constituting the main chain, a hydrated structure is formed by a short contact with water, and a polymer compound that contains water at a high moisture content is formed, with respect to the density of the side chain introduced into the main chain.

As described above, it is considered that the biocompatibility exhibited by various polymers is exhibited by the presence of intermediate water in a hydrated structure in a case where the polymer is hydrated. On the other hand, it is known that the hydration of the polymer requires a predetermined time, and the time required for the completion of the hydration varies depending on the structure and the like of the polymer. Then, it is presumed that the process of hydration of the polymer accompanies a phenomenon in which a hydrophilic portion in the polymer compound moves to an interface with the water phase near the surface of the polymer with the minimization of the interface free energy between the polymer and the water phase as a driving force, and it is considered that the ease of the movement affects the time until the hydration is completed.

In the polymer compound according to the embodiment of the present invention, it has been considered that in a case where the density of the side chain introduced into the polyolefin skeleton is increased, the mobility of the side chain moiety is improved, thereby the hydration is completed in a short time. In the polyolefin-based macromolecule, it is considered that since the polymer is constituted by a hydrocarbon chain without a polar functional group in the vicinity of the main chain as compared with a (meth)acrylic skeleton, a (meth)acrylamide skeleton, or the like, the homogeneity of the polymer matrix is high and the polarity thereof is lower. Therefore, in the polymer having a polyolefin skeleton, the influence of the introduction of the side chain moiety including a chain-like ether structure or the like on the aggregation form of the polymer molecule is particularly large, and it is presumed that the introduction of the side chain moiety of the structure at a high density reduces the homogeneity, and the distance between the molecular chains is increased, thereby improving the mobility of the side chain moiety.

In a case where a polymer or the like exhibiting biocompatibility is used by being brought into contact with blood, cells, biological tissues, or the like, it is desired to complete hydration in advance using a phosphate buffer solution, physiological saline, or the like to exhibit good biocompatibility at the start of use. On the other hand, with the composition containing a polymer compound in which hydration is completed in a short time, it is possible to exhibit good biocompatibility even in, for example, a use application in which it is difficult to perform hydration in advance before use, or a use application in which a gas phase and a liquid phase are alternately in contact with the polymer compound.

The polymer compound according to the embodiment of the present invention is characterized by containing the repeating unit represented by Formula (1). In Formula (1), R₁ represents a hydrogen atom or a monovalent hydrocarbon group having 12 or less carbon atoms which may have an ether bond, R₂ represents a divalent saturated hydrocarbon group containing a linear or branched carbon chain having 1 to 6 carbon atoms, R₃ represents a monovalent hydrocarbon group having 6 or less carbon atoms which may have an ether bond, m represents a natural number of 1 or 2, and n represents the number of repetitions of the repeating unit.

The polymer compound according to the embodiment of the present invention is different from a polymer compound in which a side chain moiety is bonded by a polar functional group, for example, such as a (meth)acrylic skeleton or a (meth)acrylamide skeleton, in that a side chain moiety is introduced by bonding one end of a divalent saturated hydrocarbon group (R₂) to a carbon chain which is a main chain. Then, it is considered that, since the polar functional group bonded to the main chain is not present, hydration in the main chain moiety is suppressed, thereby the adhesiveness to various base materials is maintained even in a wet environment for a long time.

As the above-described divalent saturated hydrocarbon group (R₂), a divalent saturated hydrocarbon group including a linear or branched carbon chain having 1 to 6 carbon atoms can be used, and as an example thereof, a divalent saturated hydrocarbon group selected from the group consisting of —CH₂—, —CH₂CH₂—, —CH(CH₃)—, —CH₂CH₂CH₂—, —CH(CH₃)CH₂—, —CH₂(CH₂)₂CH₂—, —CH(CH₃)CH₂CH₂—, —CH₂(CH)(CH₃)CH₂—, —CH(CH₃)CH(CH₃)—, —CH₂(CH₂)₃CH₂—, —CH(CH₃)(CH₂)₂CH₂—, —CH₂(CH₂)₂C(CH₃)₂—, and —CH₂(CH₂)₄CH₂— can be used.

In Formula (1), it is considered that a chain-like ether structure is formed by R₂ and R₃ linked by an ether bond, and intermediate water is generated by the chain-like ether structure during containing water, thereby exhibiting biocompatibility. In addition, by further having an ether bond inside R₃, a chain-like ether structure in which a plurality of units are linked can be obtained. Furthermore, by bonding a hydrocarbon group having an ether bond as R₁, the substantial side chain density can be improved, and the water content can be increased during saturation with water.

It is noted that the “hydrocarbon group which may have an ether bond” means that the hydrocarbon group includes a form in which two carbon atoms constituting the hydrocarbon group are bonded through an ether bond (—O—), and for example, means that in a comparison with an ethyl group (—CH₂—CH₃), the hydrocarbon group may include a group represented by —CH₂—O—CH₃. In addition, the number of ether bonds included in each hydrocarbon group is not limited to one, and a plurality of ether bonds may be included. Furthermore, in each side chain moiety included in the polymer compound, it is also possible to include hydrocarbon groups having different configurations from each other as the hydrocarbon groups corresponding to R₂ and R₃.

In addition, in the structure represented by Formula (1), in a case where a hydrocarbon group having no ether bond inside is introduced as R₃, sufficient biocompatibility is exhibited. Therefore, examples of the monovalent hydrocarbon group having 6 or less carbon atoms include methyl (CH₃), ethyl (—CH₂CH₃), propyl (—(CH₂)₂CH₃), i-propyl (—CH(CH₃)₂), n-butyl (—(CH₂)₃CH₃), i-butyl (—CH₂CH(CH₃)₂), tert-butyl (—C(CH₃)₃), n-pentyl (—(CH₂)₄CH₃), neopentyl (—CH₂C(CH₃)₃), isoamyl (—(CH₂)₂CH(CH₃)₂), tert-amyl (—C(CH₃)₂CHCH₃), n-hexyl (—(CH₂)₃CH₃), and i-hexyl (—(CH₂)₃CH(CH₃)₂), and particularly, CH₃, —CH₂CH₃, —(CH₂)₂CH₃, —(CH₂)₃CH₃, —(CH₂)₄CH₃, —(CH₂)₅CH₃, or the like can be used.

In addition, in the structure represented by Formula (1), in a case where the repetition number (m value) of carbon atoms in which a side chain is not introduced in the main chain of the polymer is set to 1 or 2, the introduction density of the side chain is increased, and the time required for hydration in a case of being brought into contact with water can be shortened.

In the polymer compound according to the embodiment of the present invention, in a case where in entire the polymer compound, the m value of the polymer compound is set to 1 or 2, and a copolymer obtained by copolymerizing a monomer constituting the repeating units having an m value of 1 and a monomer constituting the repeating units having an m value of 2 is used, the repeating unit having an m value of 1 and the repeating unit having an m value of 2 can be allowed to coexist.

In addition, for the purpose of imparting various characteristics to the polymer compound according to the embodiment of the present invention, a repeating unit other than the repeating unit represented by Formula (1) can also be introduced. For example, by introducing a hydrocarbon group having no ether bond instead of the structure of —R₂—O—R₃, it is possible to suppress the water content in a case of being brought into contact with the water phase.

In addition, also by forming a block copolymer between the group composed of the repeating unit in which the m value is 1 or 2 and the group composed of other repeating units, it is possible to impart various characteristics to the polymer compound according to the embodiment of the present invention.

In the polymer compound according to the embodiment of the present invention, the proportion of the structure represented by Formula (1) is desirably 51 mol % or more with respect to the total number (n) of repeating units constituting the polymer compound. Particularly, the proportion of the structure represented by Formula (1) is 70 mol % or more, 90 mol % or more, or 95 mol % or more, or the polymer compound is substantially composed of only the structure represented by Formula (1), thereby good biocompatibility can be exhibited.

The number-average molecular weight of the polymer compound according to the embodiment of the present invention is, for example, desirably in a range of 10,000 to 500,000 and more preferably in a range of 30,000 to 100,000. The polymer compound according to the embodiment of the present invention generates a hydrated structure composed of antifreeze water, intermediate water, or the like by hydration and exhibits predetermined hydrophilicity. In a case where the number-average molecular weight is set to 10,000 or more or 30,000 or more, good water resistance can be imparted. In addition, in a case where the number-average molecular weight is set to 500,000 or less or 100,000 or less, it is possible to ensure fluidity in a case where the polymer compound according to the embodiment of the present invention is applied to the surface of the base material by a method such as coating.

In addition, it is desirable in that the molecular weight distribution (Mw/Mn) is set in a range of 1.0 to 2.5, and more preferably in a range of 1.0 to 1.5, thereby preventing variation in various characteristics.

The polymer compound according to the embodiment of the present invention can be used as a composition mixed with another polymer compound, a filler component, a solvent, a dispersion medium, or the like, depending on the intended use and the like. In particular, the coating composition can be obtained by being dissolved in an appropriate solvent, and can be used by being applied onto the surface of various base materials by a coating method, a spray method, a dip method, or the like. The coating can be performed, for example, by applying a coating composition to the surface of various base materials to which biocompatibility is desired to be imparted, and then performing evaporation and removal of the solvent, and the like.

In a coating composition obtained by dissolving the polymer compound according to the embodiment of the present invention in various solvents, for example, additives such as an antibacterial agent, a radical scavenger, a peroxide decomposer, an antioxidant, an ultraviolet absorber, a heat stabilizer, a plasticizer, a flame retardant, and an antistatic agent can be mixed and used according to the purpose of coating, as long as the biocompatibility and the like are not significantly impaired.

In addition, after coating the surface of various members using the coating composition, the resistance of the coating film can be improved by using various crosslinking agents in the coating film or crosslinking polymer molecules by energy irradiation such as electron rays irradiation, or the like.

The polymer compound according to the embodiment of the present invention can be synthesized by polymerizing, as a monomer, an α-olefin into which a structure corresponding to —R₂—O—R₃ in Formula (1) is introduced or an α,α-disubstituted olefin into which a structure constituting R₁ in Formula (1) is introduced, using an appropriate catalyst as a polymerization initiator. Alternatively, the polymer compound can also be synthesized by polymerizing α-olefin or the like, into which has a protective group that allow the structure to be introduced after polymerization is introduced, in the presence of an appropriate catalyst, and then substituting the protective group with a desired structure.

As a catalyst for polymerizing α-olefin or the like, an heterogeneous catalyst such as a Ziegler-Natta catalyst used for polymerizing olefin can be used depending on the structure or the like of the olefin to be used, but from the viewpoints of uniformity of the structure of the polymer to be polymerized, molecular weight distribution, and the like, a homogeneous transition metal complex catalyst such as a metallocene catalyst can be preferably used.

Since the polymer compound according to the embodiment of the present invention contains an ether bond which is a polar group in the side chain moiety, the catalyst may be deactivated because of the influence of the polar group depending on the structure around the ether bond, and it may be difficult to perform the polymerization of the polymer compound having a predetermined molecular weight. In such a case, a polymer compound according to the embodiment of the present invention can also be obtained by performing polymerization of α-olefin or the like using a monomer into which a protective group is introduced at the vicinity of an ether bond, and then substituting the protective group with a predetermined structure.

In addition, the polymer compound according to the embodiment of the present invention can also be synthesized by performing an anionic polymerization using a diene-based monomer into which a structure corresponding to —R₂—O—R₃ in Formula (1) has been introduced as a raw material. That is, by performing anionic polymerization in a polar solvent or a hydrocarbon solvent using a diene-based monomer as a raw material, a polymer compound having a structure in which one side chain is introduced for every two carbon atoms constituting the main chain can be synthesized by proceeding with a 1,2-addition reaction or a 3,4-addition reaction between diene-based monomers.

In the polymer compound obtained by anionic polymerization using the above-described diene-based monomer as a raw material, a branched alkane chain is included in a portion of R₂ in Formula (1). The polymer compound containing a branched alkane chain in a portion of R₂ is also included in the polymer compound according to the embodiment of the present invention.

Furthermore, in Formula (1), the polymer compound having a structure in which m=2 can be synthesized by performing hydrogenation on a polymer obtained by ring-opening metathesis polymerization in which a cyclic compound having a 3-membered ring and having a carbon-carbon unsaturated bond with a structure corresponding to —R₂—O—R₃ in Formula (1) introduced in advance is used as a monomer, or by metathesis polymerization (ADMET polymerization) of a non-cyclic diene in which 1,4-pentadiene with a structure corresponding to —R₂—O—R₃ in Formula (1) introduced in advance is used as a monomer. In addition, a polymer compound in which m=2 in Formula (1) can also be synthesized by subjecting a trimethylene group as a monomer, in which a halogen such as a chlorine atom is bonded to both ends and a hydrogen atom is substituted with a structure corresponding to —R₂—O—R₃ in Formula (1) or the like, to a Wurtz-type coupling polymerization in the presence of an alkali metal.

The polymerization of the polymer compound according to the embodiment of the present invention can be performed by so-called solution polymerization or the like using a saturated hydrocarbon-based solvent such as hexane, heptane, butane, octane, or isobutane, an alicyclic hydrocarbon-based solvent such as cyclohexane or methylcyclohexane, an aromatic hydrocarbon-based solvent such as benzene, toluene, or xylene, or a halogen-based solvent such as methylene chloride, 1,2-dichloroethane, or chloroform as a reaction solvent.

The polymerization of the polymer compound according to the embodiment of the present invention can be performed, for example, in a range of −80° C. to 150° C. in an inert gas atmosphere such as nitrogen or argon, and more desirably can be performed in a temperature range of −50° C. to 50° C.

The film thickness of the coating film containing the polymer compound according to the embodiment of the present invention, which is provided on the surface of various base materials, is, for example, in a range of several nm to 1 mm, depending on the use application of the substrate, thereby a coating film exhibiting good biocompatibility can be constituted.

In addition, by utilizing the fact that the polymer compound according to the embodiment of the present invention exhibits high adhesiveness to various base materials, the coating composition containing the polymer compound according to the embodiment of the present invention can be used as a so-called primer, and various polymers can be laminated on the surface of the coating film for use.

In addition, in a case where a biological substance such as blood is brought into contact with the surface coated with the polymer compound according to the embodiment of the present invention, it is preferable that the polymer portion including a structure contributing to the content of the intermediate water is hydrated or the like by allowing the surface to contain water in advance.

The coating composition containing the polymer compound according to the embodiment of the present invention may coat at least a part of a surface that comes into contact with in vivo tissues, cells, blood, or the like, and the coating composition according to the embodiment of the present invention can be used as a surface treatment agent for a surface of a base material that forms a medical device or the like.

It is noted that in the present specification, the medical device is a device that is used in contact with an in vivo tissue, a cell, blood, or the like, and means, for example, a device that is used for the purpose of not impairing physiological activity exhibited by the in vivo tissue, blood, or the like. The medical device naturally includes, for example, a form in which the medical device is placed inside a living body, a form in which the medical device is used in contact with a tissue or blood in a state in which the in vivo tissue is exposed, a form in which the medical device is used in contact with a tissue in a state in which the medical device is embedded in an in vivo tissue such as a bone tissue, and a form in which the medical device is used in contact with blood which is a component in a living body taken out of the body in an extracorporeal circulation medical material. In addition, the term “used for medical use” includes the meaning of “used in contact with an in vivo tissue or blood” or “used as planned to be in contact with an in vivo tissue or blood”.

The material and shape of the member constituting the medical device or the like coated with the coating composition according to the embodiment of the present invention are not particularly limited, and may be, for example, any of a porous body, a fiber, a nonwoven fabric, a particle, a film, a sheet, a tube, a hollow fiber, a powder, or the like. Examples of the material include natural macromolecules such as silk and hemp, synthetic macromolecules such as nylon, polyester, polyacrylonitrile, polyolefin, halogenated polyolefin, polyurethane, polyamide, polycarbonate, polysulfone, polyether sulfone, poly(meth)acrylate, an ethylene-vinyl alcohol copolymer, and a butadiene-acrylonitrile copolymer, and mixtures thereof. In particular, the coating composition containing the polymer compound according to the embodiment of the present invention can be preferably used for surfaces that are difficult to ensure adhesiveness with a macromolecule material, such as metal, ceramics, glass, and a composite material thereof.

The coating composition according to the embodiment of the present invention can be used for medical devices that are used in contact with in vivo tissues or blood, and it is desirable that the coating composition is used for at least a part of a surface of the medical device in contact with the in vivo tissues or blood, preferably almost all of a surface of the medical device in contact with the blood, such as an intracorporeal embedded type artificial organ or therapeutic instrument, extracorporeal circulation type artificial organs, and catheters (catheters for circulatory organs such as a catheter for angiography, a guide wire, and a catheter for PTCA, catheters for digestive organs such as a gastric tube catheter, a gastrointestinal catheter, and an esophageal tube, and catheters for urology such as a tube, a urinary catheter, and a urethral catheter).

In addition, in an artificial lung of a type in which a large number of porous hollow fiber membranes for gas exchange are stored in a housing, blood flows to an outer surface side of the hollow fiber membrane, and an oxygen-containing gas flows into the hollow fiber membrane, the outer surface of the hollow fiber membrane or an outer surface layer of the hollow fiber membrane may be coated with the coating composition according to the embodiment of the present invention.

In addition, the coating composition according to the embodiment of the present invention may be coated on at least a part of a surface of a dialysis device which comes into contact with blood, the dialysis device having a dialysis solution circuit including at least one dialysis solution container filled with a dialysis solution and at least one waste liquid container for collecting the dialysis solution, and a liquid feeding unit that feeds the dialysis solution starting from the dialysis solution container or ending at the waste liquid container, or the coating composition according to the embodiment of the present invention may be also used for the purpose of constituting various diagnostic chips by being coated on a surface of a base material or a surface of particles, which comes into contact with various proteins, cells, and the like, by utilizing the selective adsorptivity with proteins, cells, and the like exhibited by the surface having a predetermined amount of intermediate water.

In addition, the surface formed of the polymer compound according to the embodiment of the present invention can be preferably used as a support for cell culture, which enables cells to adhere and be maintained in a preferred form, by applying the coating composition according to the embodiment of the present invention, or the like. That is, the support for cell culture, of which the surface is formed of the polymer compound according to the embodiment of the present invention, is not particularly limited as long as it is a living cell that adheres to a substrate, and can be applied to cell culture of epidermal cells, vascular endothelial cells, oral endothelial cells, gastrointestinal epithelial cells such as esophageal epithelial cells, gastric epithelial cells, and intestinal epithelial cells, respiratory epithelial cells such as nasal cavity mucous membrane epithelial cells, tracheal epithelial cells, and alveolar epithelial cells, exocrine gland cells such as sweat gland cells, sebaceous gland cells, apocrine gland cells, and mammary gland cells, endocrine gland cells such as salivary gland epithelial cells, lacrimal gland cells, pancreatic Langerhans islet cells, adrenal medullary cells, adrenal cortical cells, pineal gland cells, pituitary gland cells, and thyroid cells, visceral parenchymal cells such as hepatocytes, renal epithelial cells, pancreatic cells, and adrenal cells, sensory organ cells such as taste bud cells, olfactory epithelial cells, and hair cells, nerve cells, glial cells such as astrocytes and Schwann cells, muscle cells such as myocardial cells, skeletal muscle cells, and smooth muscle cells, mesenchymal cells such as fibroblasts, stromal cells, connective tissue cells, chondrocytes, and osteoblasts, and thymic epithelial cells, uterine epithelial cells, ovarian follicular cells, oviduct epithelial cells, testicular epithelial cells, Leydig cells, and the like.

In addition, the support for cell culture, of which the surface is formed of the polymer compound according to the embodiment of the present invention, can be used for culturing various stem cells such as stem cells having differentiation pluripotency, such as embryonic stem cells (ES cells), induced pluripotent stem cells (iPS cells), embryonal carcinoma cells (EC cells), embryonic germ stem cells (EG cells), nuclear transfer ES cells, and somatic cell-derived ES cells, tissue stem cells such as hematopoietic stem cells, bone marrow-derived mesenchymal stem cells, adipose tissue-derived mesenchymal stem cells, other mesenchymal stem cells, MUSE cells, and neural stem cells, stem cells having multipotential, and progenitor cells in various tissues such as the liver, the pancreas, the adipose tissue, the bone tissue, and the cartilage tissue. In the culture of stem cells using a support for cell culture, the surface of which is formed of the polymer compound according to the embodiment of the present invention, due to the fact that the cells can be adhered and maintained in a preferred form, or the like, promotion, suppression, or the lik of differentiation occurs depending on the characteristics of the stem cells to be cultured. Therefore, cell culture according to the purpose of the culture can be performed.

Hereinafter, the present invention will be described in more detail using examples, but the present invention is not limited to the examples and the like to understood.

### EXAMPLES

### 1. Synthesis of Polymer Compound

For chemicals and the like in the following examples, commercially available products were used as they were unless otherwise specified.

For the structural analysis of the monomer and the polymer, 1H NMR measurement was performed using an NMR measurement device (manufactured by Bruker Corporation, AVANCE 111 400 MHz or 600 MHz). The chemical shift was based on CDCl₃ (¹H: 7.26 ppm).

### Synthesis Example 1

In Synthesis Example 1, a polymer compound composed of a repeating unit represented by Formula (2) was synthesized. The repeating unit represented by Formula (2) corresponds to a structure in which R₁ is a hydrogen atom, R₂ is a trimethylene group, R₃ is a methyl group, and m value is set to m=1 in Formula (1). In Synthesis Example 1, from the viewpoint of molecular weight distribution and the like of the polymer compound to be polymerized, a polymer compound was synthesized by a method in which a polymerization reaction was caused in a state where a protective group was introduced into a monomer to be used, and then the protective group included in the polymerized substance was substituted to obtain a structure of Formula (2).

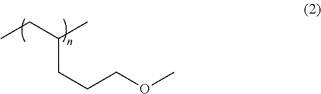

As shown in the following scheme, a tert-butyldimethylsilyl (TBS) group as a silyl protective group was provided for a hydroxy group of 4-pentene-1-ol as a starting material.

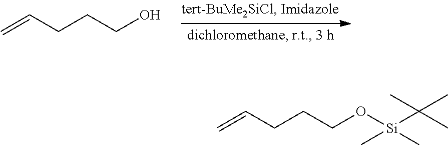

In a three-neck flask, 17.77 g (206.3 mmnol) of 4-pentene-1-ol (>98.0% (GC), Tokyo Chemical Industry Co., Ltd.), 20.55 g (301.9 mmol) of imidazole (>99.0% (GC) (Titration), Tokyo Chemical Industry Co., Ltd.), and 400 mL of dichloromethane (DCM) (dehydrated, Super, >99.5% (GC), Kanto Chemical Co., Inc.) as a reaction solvent were mixed and stirred at 0° C. for 10 minutes. Furthermore, 36.93 g (245.0 mmol) of tert-butyldimethylsilyl chloride (>98.0% (GC), manufactured by Tokyo Chemical Industry Co., Ltd.) was added thereto, and the mixture was stirred at room temperature for 3 h.

Thereafter, water was added to the reaction solution to dilute the reaction solution, and then the organic layer was collected using a separatory funnel. After removing moisture from the collected organic layer with MgSO₄, the filtrate collected by suction filtration was concentrated with an evaporator, and then the high-polarity component was removed using column chromatography (filler: Silica gel 60N, developing solvent: hexane, TLC: Rf=0.30 (4-pentene-1-OTBS)), and then the solution was concentrated again with an evaporator and subjected to distillation under reduced pressure (34° C./1 mmHg) in the presence of CaH₂ to obtain a colorless and transparent liquid (yield amount: 35.08 g, yield: 87.5%).

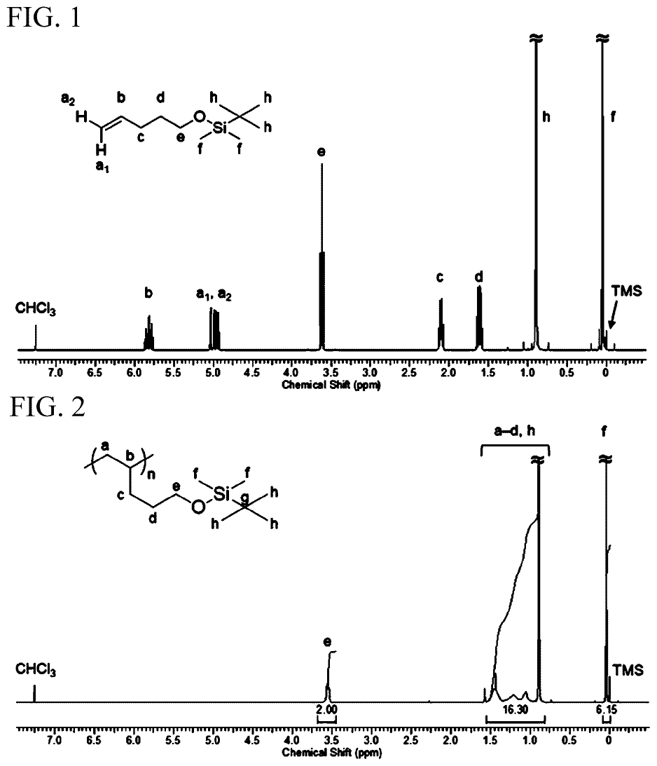

FIG. 1 shows a ¹H-NMR spectrum of the product obtained above. As shown in FIG. 1, a peak derived from a TBS group was observed in the product, and it was considered that 4-pentene-1-OTBS was generated. The conversion rate of the addition of the protective group was estimated to be 99% or more.

Using the obtained product as a monomer, polymerization was performed according to the following scheme using bis(pentamethylcyclopentadienyl)dimethylzirconium(IV) (Cp*₂ZrMe₂, 99%, Strem Chemicals, Inc.) as a metallocene complex and B(C₆F₅)₃ (>98.0% (NMR), Tokyo Chemical Industry Co., Ltd.) as a co-catalyst.

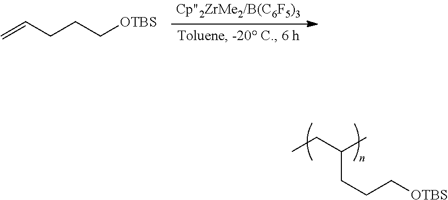

A solution A obtained by adding toluene (5 mL) to 4-pentene-1-OTBS (24.02 g/120.0 mmol) obtained above and a solution B obtained by adding Cp*₂ZrMe₂ (158.2 mg/0.404 mmol) and B(C₆F₅)₃ (102.6 mg/0.200 mmol) to toluene (15 mL) were prepared, the solution A and the solution B were mixed with each other in a state of being cooled to −78° C., allowed to stand at −78° C. for 20 min, then transferred to an environment of −20° C., and stirred to perform a polymerization reaction for 6 hours.

Thereafter, the reaction solution was mixed with an excess amount of methanol to stop the reaction, and the product was precipitated. The separated precipitate was dissolved in tetrahydrofuran (THF), and then mixed with an excess amount of methanol to perform reprecipitation. The process was repeated to purify the precipitate, and finally THF was evaporated and removed to obtain a colorless and transparent viscous substance (yield amount: 22.43 g, yield: 93.4%).

FIG. 2 shows a ¹H NMR spectrum of the product obtained above. As shown in FIG. 2, in the product, it was confirmed that the signal derived from the double bond of the monomer disappeared and the polymerization proceeded. In addition, from the results of the GPC measurement, the number-average molecular weight (Mn) was estimated to be 43,400 g/mol, and the ratio (molecular weight distribution) to the weight-average molecular weight (Mw) was estimated to be Mn/Mw=2.1.

Next, the above-described product was deprotected using tetrabutylanmnonium fluoride (TBAF) according to the following scheme.

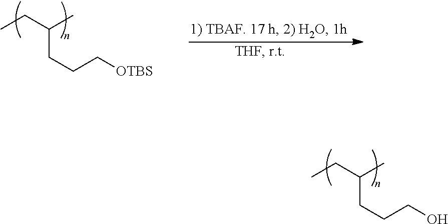

30 mL of a THF solution of TBAF (1.0 M, Sigma-Aldrich Corporation) was added to the above-described product (1.14 g, 5.69 mmol in terms of monomer unit), and the mixture was stirred at room temperature for 17 hours, and then an excessive amount of deionized water was added thereto, and the mixture was stirred for 1 hour. The reaction solution was added dropwise to THF, the mixture was stirred to precipitate the polymer component, and TBAF and the like eluted to THF were separated by decantation.

After the precipitate was collected with methanol, a large excess of a cation exchange resin (Amberlyst 15 (registered trademark)) and CaCO₃ were added thereto to remove the remaining TBAF and the like, and the mixture was stirred at room temperature for 6 hours to ionically bond the TBAF and the like to the ion exchange resin. The filtrate obtained by filtering the reaction solution was concentrated using an evaporator and dried in a vacuum oven at 60° C. for 3 hours to obtain a colorless and transparent viscous substance (crude yield of 85.7%).

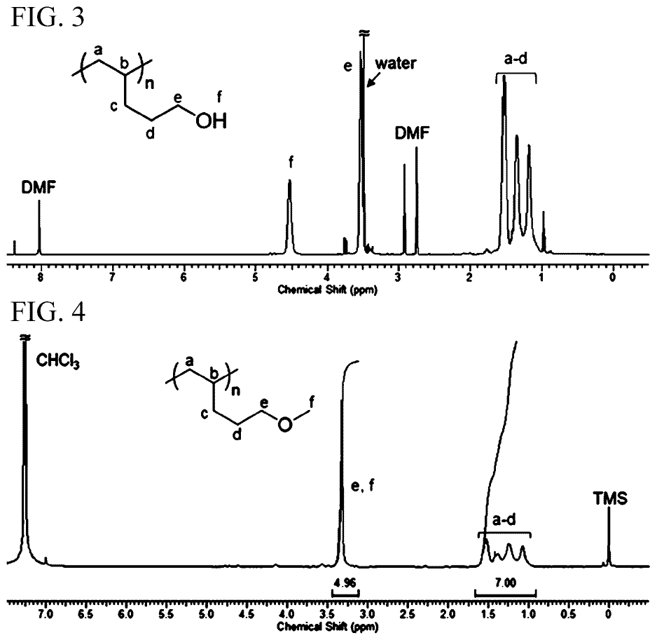

FIG. 3 shows a ¹H NMR spectrum of the product obtained above. As shown in FIG. 3, it was observed that the peak derived from the TBS group disappeared and the peak derived from the hydroxy group appeared by the above-described treatment, and it was confirmed that deprotection was performed.

Next, the hydroxy group introduced above was methylated by the following scheme to obtain the structure represented by Formula (2). In this scheme, NaH was used as a base for generating an alkoxide that gives an ether, and a hydrogen atom of a hydroxy group was methylated by a reaction with methyl iodide in an environment in which NaH was present.

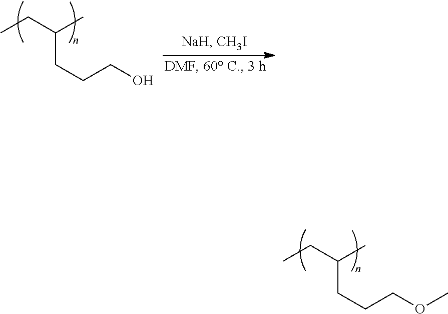

Paraffin was separated by using NaH (Sigma-Aldrich Corporation) dispersed in paraffin, and mixing with hexane (super dehydrated, >96.0% (Capillary GC), FUJIFILM Wako Pure Chemical Corporation) such that the content of NaH was 44.00 mmol, then 10 mL of N,N-dimethylformamide (DMF) (>99.5% (GC), Kanto Chemical Co., Inc.) was mixed therewith, and the mixture was stirred in a nitrogen atmosphere to obtain a dispersion liquid.

A solution obtained by dissolving the above-described viscous substance (0.97 g) having a hydroxy group in 20 mL of DMF was added dropwise to the above-described dispersion liquid containing NaH, and the mixture was stirred at 60° C. for 1 hour and then cooled to room temperature. Then, 9.2 g (64.82 mmol) of methyl iodide (>95% (GC), FUJIFILM Wako Pure Chemical Corporation) was added dropwise thereto, and the mixture was stirred again at 60° C. for 3 hours to methylate the hydrogen atom of the hydroxy group.

After completion of the reaction, the mixture was cooled to room temperature, methanol was added dropwise thereto to inactivate the remaining NaH, and the mixture was added dropwise to an excess amount of pure water to precipitate a polymer component, which was then neutralized with hydrochloric acid. After removing the supernatant, chloroform was mixed to dissolve a soluble component containing a target polymer compound, the solution was filtered to separate a precipitate, and further mixed with a large excess of pure water to precipitate the target polymer compound and separate a water-soluble component. After removing the water in the supernatant of the mixture, a target polymer compound was collected with chloroform, and then chloroform was evaporated and removed to collect 0.39 g of a product (yield: 34.6%).

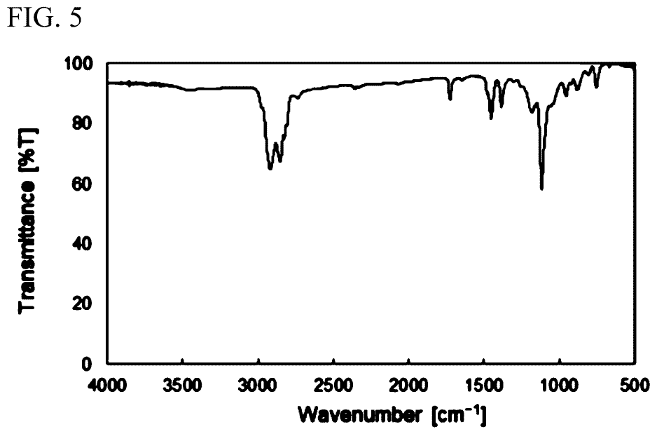

FIG. 4 shows a ¹H NMR spectrum of the product obtained above. In addition, FIG. 5 shows an infrared absorption (IR) spectrum of the product obtained above. As shown in FIG. 4, the product is considered to be composed of the repeating unit represented by Formula (2). In addition, in the IR spectrum shown in FIG. 5, it was also considered that the hydroxy group was methylated according to the above scheme since an absorption peak derived from the stretching vibration of OH present in the vicinity of 3,000 to 3,700 (cm-1) was not observed. Based on the molecular weight before the above-described deprotection, the molecular weight (Mn) of the above-described product was estimated to be 21,700 g/mol.

In addition, in the obtained product, a glass transition temperature (Tg) of −57° C. (dry state) and −61° C. (water-containing state) was observed, and a melting point (Tm) was not observed. Therefore, it was speculated that the obtained product was a polymer having a low degree of crystallization or an amorphous structure.

Since the polymer compound synthesized in Synthesis Example 1 contains two carbons in the main chain moiety of the repeating unit, the polymer compound may be represented by “P2” in the present specification.

### Synthesis Example 2

In Synthesis Example 2, a polymer compound composed of a repeating unit represented by Formula (3) was synthesized by the method described in Patent Document 3. The repeating unit represented by Formula (3) corresponds to a structure in which R₁ is a hydrogen atom, R₂ is a trimethylene group, R₃ is a methyl group, and m value is set to m=2 in Formula (1).

Since the polymer compound synthesized in Synthesis Example 2 contains four carbons in the main chain moiety of the repeating unit, the polymer compound may be represented by “P4” in the present specification.

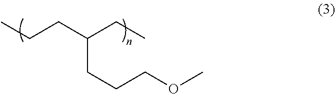

### Synthesis Example 3

PMEA, which has been known to exhibit biocompatibility in the related art, was synthesized by the following method and used. Formula (4) shows a structure of PMEA.

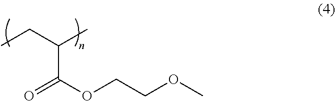

The reaction solution obtained by mixing 15.2 g (117 mmol) of 2-methoxyethyl acrylate, 60.5 g of 1,4-dioxane, and 15.4 mg (0.094 mmol) of azobisisobutyronitrile was stirred for 30 minutes while passing dried nitrogen gas, and the reaction system was subjected to nitrogen substitution. Thereafter, the mixture was stirred in an oil bath set at 75° C. for 6 hours under a nitrogen stream to perform polymerization, thereby obtaining 13.8 g of a methoxymethyl acrylate polymer (yield of 92%). The obtained polymer had a number-average molecular weight (Mn) of 33,000 g/mol and a molecular weight distribution (Mw/Mn) of 3.2.

### 2. Evaluation of Polymer Compound

### (1) Production of Sample Substrate

Using a coating composition obtained by dissolving each polymer compound synthesized above in a solvent by the method described below to form a coating film of each polymer compound on the surface of the resin base material, which was used for subsequent evaluation.

The polymer compound (P2) synthesized in Synthesis Example 1 and the polymer compound (P4) synthesized in Synthesis Example 2 were dissolved in THF as a solvent to prepare a polymer solution having a polymer content of 0.2 g (0.2 (wt/vol %)) in 100 mL of the solution. In addition, PMEA was dissolved in methanol as a solvent to prepare a polymer solution having a concentration of 0.2 (wt/vol %).

After washing a resin base material (polypropylene (PP) resin, PET resin having a roughened surface with nitrogen plasma) having a diameter of 14 mm with methanol, 40 μL of each polymer solution was added dropwise to each base material, and each of the above-described polymer solution was coated under the conditions of 500 rpm (5 s), 2,000 rpm (10 s), SLOPE (5 s), 4,000 rpm (5 s), and SLOPE (4 s) using a spin coater. Thereafter, the solvent was allowed to evaporate by standing indoors for 15 minutes, the coating was performed again under the same conditions, then the coating was dried at 25° C. for 24 hours or more to prepare a sample, and evaluation was performed using the sample as follows.

### (2) Evaluation of Adhesiveness of Polymer Compound to Resin Substrate

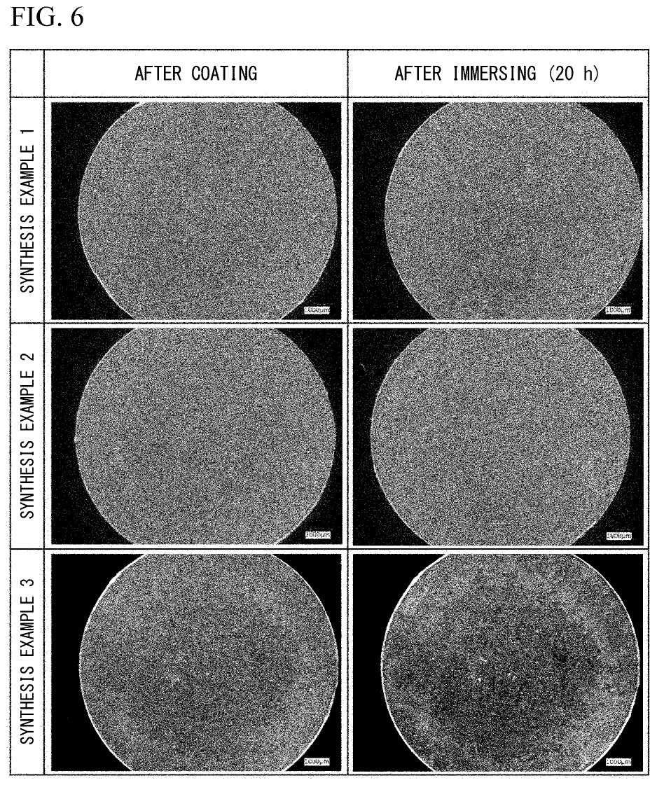

FIG. 6 shows stereoscopic micrographs of the appearance of the PP resin substrate in a case where each polymer compound is applied thereto and the appearance of the PP resin substrate after the PP resin substrate to which each polymer compound is applied is immersed in a phosphate buffer solution (PBS (−)) at room temperature for 20 hours.

The spotted pattern was confirmed after the film formation in the substrate coated with the PMEA synthesized in Synthesis Example 3, it was presumed that the PMEA was finely aggregated after the coating composition was applied using a spin coater and before the solvent was dried. In addition, it was presumed that, in a state of being immersed in PBS (−) and then dried, the range and degree of the spotted pattern were enlarged, and thus the non-uniformity of the coating film was increased because of the flow of the PMEA hydrated in PBS (−). In addition, it was considered that this is because the interface energy between PP and PMEA, which are the base materials, is high, and PMEA causes so-called dewetting.

On the one hand, in the substrate coated with P2 or P4 synthesized in Synthesis Example 1 or 2, it was observed that a uniform coating film was maintained even after the film formation and in a state where the substrate was immersed in PBS (−) and then dried, and it was observed that the adhesiveness between the substrate and PP as a base material was excellent.

On the other hand, in the substrate coated with each polymer compound in the same manner using the PET resin having a surface hydrophilized with nitrogen plasma as a base material, a uniform coating film was maintained for all of the P2, P4, and PMEA even after the film formation and in a state where the substrate was immersed in PBS (−) and then dried. It is presumed that this result suggests that P2 and P4 exhibit good adhesiveness particularly to a resin having low polarity.

### (3) Evaluation of Hydrophilicity Exhibited by Polymer Compound

Using the substrate coated with each polymer compound with the PET resin as a base material, the contact angle of a water droplet dropped in a gas phase was measured (liquid droplet method). For the measurement, pure water (2 μL) was dropped onto each substrate surface, and using a fully automatic contact angle meter (Drop Master, DMo-501SA, Kyowa Interface Science, Japan), the contact angle of the liquid droplet was measured for 60 seconds after the liquid droplet was landed using the θ/2 method.

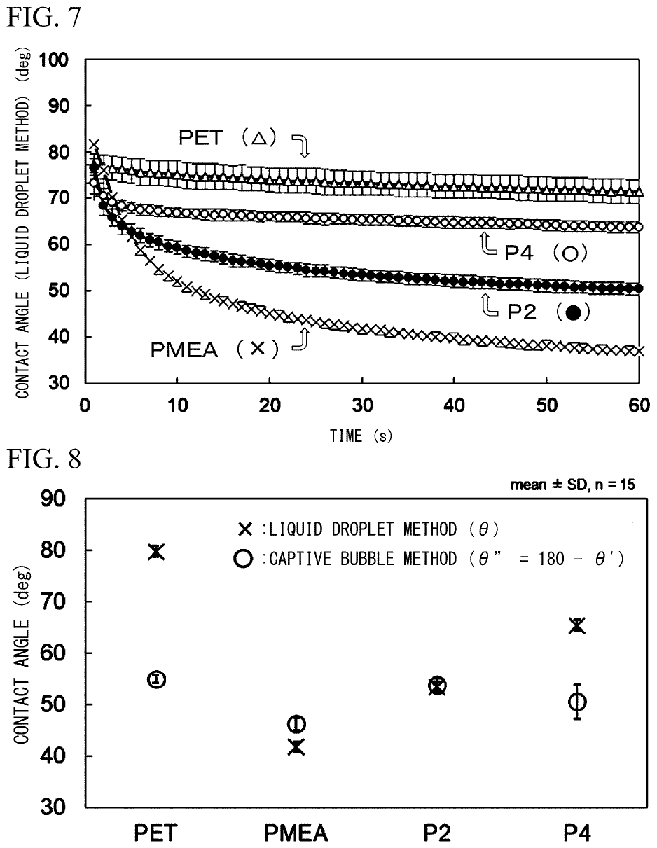

FIG. 7 shows the contact angle (θ) on the surface of each polymer compound and the surface of the PET substrate on which coating is not performed. As shown in FIG. 7, in P2 according to Synthesis Example 1, the contact angle was rapidly reduced immediately after the liquid droplet was brought into contact, and the contact angle of about 55 degrees was exhibited after 60 seconds. On the other hand, in P4 according to Synthesis Example 2, the contact angle of about 67 degrees was exhibited after 60 seconds. In addition, in the PMEA exhibiting high biocompatibility, the contact angle of about 35 degrees was observed.

As shown in FIG. 7, it is presumed that the phenomenon in which the contact angle is reduced after the contact of the liquid droplet is due to the alignment of a hydrophilic side chain functional group or the like in the polymer compound at the interface to minimize the interface free energy at the interface between the liquid droplet and the polymer compound and to stabilize the interface energetically. Then, it is presumed that the speed and degree of alignment of the hydrophilic side chain functional group or the like on the interface change depending on the polarity and density of the hydrophilic functional group of the macromolecule and the mobility of the side chain functional group or the like in the polymer.

For each of the above-described substrates, the contact angle of the air bubble was measured by an captive bubble method in which air bubbles (2 μL) were attached in a state of being immersed in pure water and held for 24 hours. FIG. 8 shows a value (θ″) converted by θ″=180−θ′ in comparison with the contact angle (θ) measured by the liquid droplet method for the contact angle (θ′) of the air bubbles by a captive bubble method. Each contact angle (θ, θ′) indicates a value 30 seconds after the liquid droplet or the air bubble comes into contact.

In a case where the measurement is performed by a liquid droplet method and a captive bubble method on a surface in which the state of the solid surface is the same in the gas phase and the liquid phase, a relationship of θ+θ′=180 degrees is established theoretically between the contact angle (θ) by the liquid droplet method and the contact angle (θ′) by a captive bubble method. That is, in a case where the rate of each of the surface change (dry state→hydrated state) during the measurement of the contact angle by a liquid droplet method and the surface change (hydrated state→dry state) during the measurement of the contact angle by a captive bubble method is sufficiently fast, it is considered that the values of θ and θ″ shown in FIG. 8 are equal to each other.

As shown in FIG. 8, in P2 (Synthesis Example 1) and PMEA (Synthesis Example 3), the values of θ and θ″ were almost equal, whereas in P4 (Synthesis Example 2), a difference was observed between the values of θ and θ″. As a reason for the difference in the behavior of the contact angle with the pure water, in P2, it was considered that since the mobility of the side chain moiety exhibiting hydrophilicity in the polymer was high, the responsiveness in a case where water droplets came into contact with in the air or air bubbles came into contact with in the water was high.

### (4) Evaluation of Biocompatibility Exhibited by Polymer Compound

It is known that, in a case where blood comes into contact with an external foreign substance, a thrombus is generated by the action of platelets in the blood, whereas on the surface of a substance having intermediate water, the generation of a thrombus is suppressed by suppressing the adhesion of the platelets. Then, the degree of biocompatibility of the substance can be evaluated according to the degree of suppression of platelet adhesion.

The evaluation of platelet adhesion occurring on the surface of the substrate coated with each polymer compound was performed by the method described below.

Human whole blood (containing 3.2% sodium citrate) within 4 days after blood sampling, which was sampled in the United States, was uniformly mixed, and then centrifuged at 400 rcf (1,500 rpm) for 5 minutes, and the supernatant as a plasma component was collected to obtain platelet rich plasma (PRP). In addition, the remaining blood was centrifuged at 2,500 ref (4,000 rpm) for 10 minutes, and the supernatant was collected to obtain platelet poor plasma (PPP). The concentration of platelets present in the PRP was measured using a hemocytometer, and the PRP was diluted with PPP such that the seeding density on the substrate was 4×10⁷ cells/cm², thereby preparing a platelet suspension.

Three PET substrates coated with each of the polymer compounds of Synthesis Examples 1 to 3 and three PET substrates not coated were used (n=3), and each substrate having a size of 8 mm square was fixed to a sample table for a scanning electron microscope (SEM) with conductive tape, and then each surface was sufficiently hydrated by incubating with 200 μL of PBS (−) at 37° C. for 20 hours.

200 μL of the platelet suspension prepared above was seeded on each substrate and incubated at 37° C. for 1 hour, the suspension was then removed, washing was performed twice using PBS (−), and then the platelets were fixed by immersing the platelets in PBS (−) containing 1% glutaraldehyde at room temperature for 2 hours. After the fixing, the substrate was washed by immersing the substrate in PBS (−) for 10 minutes, immersing the substrate in PBS (−):pure water=1:1 for 8 minutes, and immersing the substrate in pure water for 8 minutes in this order. After air-drying the substrate after washing for several days, the substrate surface was observed at each of five sites (magnification of 1,500 times) using a SEM (TM3030Plus, HITACHI), and platelets observed in each visual field were counted for each activation degree (type I to type III). The activation degree was counted by classifying the activation degree into a form (type I) in which the degree of activation was small and the platelets adhered while maintaining a form of a circular shape similar to that in the blood, an adhered form (type II) in which the degree of activation was moderate and the pseudopod formation was observed, and an adhered form (type III) in which the degree of activation was large and the cell was extended.

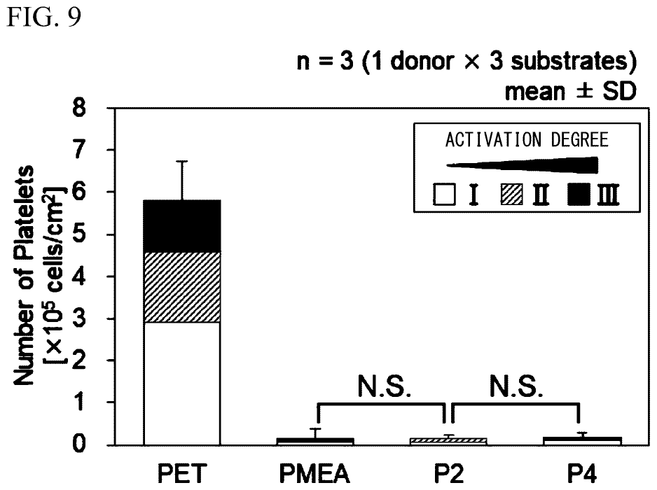

FIG. 9 shows the evaluation results of platelet adhesion on the substrate surface coated with each polymer compound. As shown in FIG. 9, it was shown that on the surfaces of P2 (synthesis example 1) and P4 (synthesis example 2), the platelet adhesion was suppressed to the same level as that of PMEA (synthesis example 3) having high biocompatibility and high biocompatibility was exhibited.

### INDUSTRIAL APPLICABILITY

The polymer compound according to the present invention exhibits high biocompatibility and exhibits good adhesiveness to various base materials, and thus can be preferably used as a material for forming a surface where impartment of biocompatibility is desired, such as a surface of a medical device.

1. A polymer compound comprising:
a repeating unit represented by Formula (1), provided that in Formula (1), R₁ represents a hydrogen atom or a monovalent hydrocarbon group having 12 or less carbon atoms which may have an ether bond, R₂ represents a divalent saturated hydrocarbon group containing a linear or branched carbon chain having 1 to 6 carbon atoms, R₃ represents a monovalent hydrocarbon group having 6 or less carbon atoms which may have an ether bond, m represents a natural number of 1 or 2, and n represents the number of repetitions of the repeating unit,

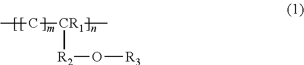

2. The polymer compound according to claim 1,
wherein R₂ is a divalent saturated hydrocarbon group selected from the group consisting of —CH₂—, —CH₂CH₂—, —CH(CH₃)—, —CH₂CH₂CH₂—, —CH(CH₃)CH₂—, —CH₂(CH₂)₂CH₂—, —CH(CH₃)CH₂CH₂—, —CH₂(CH)(CH₃)CH₂—, —CH(CH₃)CH(CH₃)—, —CH₂(CH₂)₃CH₂—, —CH(CH₃)(CH₂)₂CH₂—, —CH₂(CH₂)₂C(CH₃)₂—, and —CH₂(CH₂)₄CH₂—.

3. The polymer compound according to claim 1,
wherein R₃ is a monovalent hydrocarbon group selected from the group consisting of —CH₃, —CH₂CH₃, —(CH₂)₂CH₃, —(CH₂)₃CH₃, —(CH₂)₄CH₃, and —(CH₂)₅CH₃.

4. The polymer compound according to claim 1,
wherein a proportion of a structure represented by Formula (1) to the number (n) of repeating units constituting the polymer compound is 51 mol % or more.

5. A polymer composition comprising
the polymer compound according to claim 1.

6. A coating composition obtained by dissolving the polymer compound according to claim 1.

7. A medical device comprising:
a surface at least a part of which is coated with the polymer compound according to claim 1.
